(19) United States
(12) Patent Application Publication
(10) Pub. No.: US 2025/0373287 A1
(43) Pub. Date: Dec. 4, 2025

(54) MULTIPLE-INPUT AND MULTIPLE-OUTPUT CHANNEL FEEDBACK WITH DICTIONARY LEARNING

(71) Applicant: QUALCOMM Incorporated, San Diego, CA (US)

(72) Inventors: Hyojin LEE, San Diego, CA (US); Yu ZHANG, San Diego, CA (US); Jing SUN, San Diego, CA (US)

(21) Appl. No.: 18/732,073

(22) Filed: Jun. 3, 2024

(51) Int. Cl. H04B 7/0417; H04B 7/06; H04L 25/02

(52) U.S. Cl. CPC H04B 7/0417; H04B 7/0663; H04L 25/0228; H04L 25/0242

(57) ABSTRACT

Some examples of the techniques described herein may provide multiple-input and multiple-output (MIMO) channel state feedback (CSF) based on dictionary learning. An adaptive dictionary may provide an enhanced compression ratio for CSF information relative to a fixed dictionary. Various approaches for applying a sparse representation for CSF are provided herein. Techniques for applying dictionary learning for CSF procedures are also provided herein. Sparse representation may be utilized in wireless communications. Sparse representation may include representing information with a reduced quantity of information. For example, a sparse representation of a signal based on dictionary learning may be utilized to compress transmission data with an adaptive basis to provide enhanced efficiency for computational or communication resource utilization. Adapting the dictionary may improve compression or performance for communicating signals via a MIMO channel. For example, a UE may utilize a learned dictionary to compress channel state information.

### FIELD OF TECHNOLOGY

The following relates to wireless communications, including multiple-input and multiple-output channel feedback with dictionary learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a reference signal from a network entity via a multiple-input and multiple-output (MIMO) channel, where an estimate of the MIMO channel is generated based on the reference signal, transmitting information associated with a dictionary matrix for channel status feedback or channel state feedback (CSF) compression, where the information is based on the estimate of the MIMO channel, and communicating data via the MIMO channel, where the data is processed based on the dictionary matrix.

A UE for wireless communications is described. The UE may include one or more memories storing processor executable code, and one or more processors coupled with the one or more memories. The one or more processors may individually or collectively be operable to execute the code to cause the UE to receive a reference signal from a network entity via a MIMO channel, where an estimate of the MIMO channel is generated based on the reference signal, transmit information associated with a dictionary matrix for CSF compression, where the information is based on the estimate of the MIMO channel, and communicate data via the MIMO channel, where the data is processed based on the dictionary matrix.

Another UE for wireless communications is described. The UE may include means for receiving a reference signal from a network entity via a MIMO channel, where an estimate of the MIMO channel is generated based on the reference signal, means for transmitting information associated with a dictionary matrix for CSF compression, where the information is based on the estimate of the MIMO channel, and means for communicating data via the MIMO channel, where the data is processed based on the dictionary matrix.

A non-transitory computer-readable medium storing code for wireless communications is described. The code may include instructions executable by one or more processors to receive a reference signal from a network entity via a MIMO channel, where an estimate of the MIMO channel is generated based on the reference signal, transmit information associated with a dictionary matrix for CSF compression, where the information is based on the estimate of the MIMO channel, and communicate data via the MIMO channel, where the data is processed based on the dictionary matrix.

In some examples of the method, UEs, and non-transitory computer-readable medium described herein, transmitting the information may include operations, features, means, or instructions for transmitting a first indication of the dictionary matrix and transmitting a second indication of a set of representation vectors, the set of representation vectors being based on the estimate of the MIMO channel.

In some examples of the method, UEs, and non-transitory computer-readable medium described herein, the set of representation vectors may be based on a gram matrix of the estimate of the MIMO channel.

In some examples of the method, UEs, and non-transitory computer-readable medium described herein, the first indication of the dictionary matrix may be transmitted in accordance with a first periodicity and the second indication of the set of representation vectors may be transmitted in accordance with a second periodicity and the second periodicity may be shorter than or equal to the first periodicity.

In some examples of the method, UEs, and non-transitory computer-readable medium described herein, the dictionary matrix includes a spatial domain dictionary matrix and a frequency domain dictionary matrix.

Some examples of the method, UEs, and non-transitory computer-readable medium described herein may further include operations, features, means, or instructions for compressing the CSF based on the spatial domain dictionary matrix and the frequency domain dictionary matrix.

In some examples of the method, UEs, and non-transitory computer-readable medium described herein, transmitting the information associated with the dictionary matrix may include operations, features, means, or instructions for transmitting an indication of a representation vector, an indication of an updated dictionary matrix, an indication of an error matrix, an indication of a set of error vectors, or a combination thereof.

In some examples of the method, UEs, and non-transitory computer-readable medium described herein, the indication of the updated dictionary matrix may be transmitted in accordance with a first periodicity and the indication of the representation vector may be transmitted in accordance with a second periodicity and the second periodicity may be shorter than or equal to the first periodicity.

Some examples of the method, UEs, and non-transitory computer-readable medium described herein may further include operations, features, means, or instructions for receiving a signal indicating a configuration of a learning ratio, where the information associated with the dictionary matrix may be based on the learning ratio.

In some examples of the method, UEs, and non-transitory computer-readable medium described herein, the reference signal may be precoded based on the dictionary matrix and the method, apparatuses, and non-transitory computer-readable medium may include further operations, features, means, or instructions for estimating a representation vector based on the estimate of the MIMO channel, where the information associated with the dictionary matrix indicates the representation vector.

In some examples of the method, UEs, and non-transitory computer-readable medium described herein, receiving the reference signal may include operations, features, means, or instructions for receiving a first reference signal that may be transmitted from a first quantity of antenna ports, where transmitting the information includes transmitting an indication of an update of the dictionary matrix based on the first reference signal and receiving a second reference signal that may be transmitted from a second quantity of one or more antenna ports that may be less than the first quantity of antenna ports, where transmitting the information includes transmitting information associated with a representative vector that may be based on the second reference signal.

A method for wireless communications by a network entity is described. The method may include outputting a reference signal from the network entity via a MIMO channel, obtaining information associated with a dictionary matrix for CSF compression, where the information is based on the reference signal via the MIMO channel, and communicating data via the MIMO channel, where the data is processed based on the dictionary matrix.

A network entity for wireless communications is described. The network entity may include one or more memories storing processor executable code, and one or more processors coupled with the one or more memories. The one or more processors may individually or collectively be operable to execute the code to cause the network entity to output a reference signal from the network entity via a MIMO channel, obtain information associated with a dictionary matrix for CSF compression, where the information is based on the reference signal via the MIMO channel, and communicate data via the MIMO channel, where the data is processed based on the dictionary matrix.

Another network entity for wireless communications is described. The network entity may include means for outputting a reference signal from the network entity via a MIMO channel, means for obtaining information associated with a dictionary matrix for CSF compression, where the information is based on the reference signal via the MIMO channel, and means for communicating data via the MIMO channel, where the data is processed based on the dictionary matrix.

A non-transitory computer-readable medium storing code for wireless communications is described. The code may include instructions executable by one or more processors to output a reference signal from the network entity via a MIMO channel, obtain information associated with a dictionary matrix for CSF compression, where the information is based on the reference signal via the MIMO channel, and communicate data via the MIMO channel, where the data is processed based on the dictionary matrix.

In some examples of the method, network entities, and non-transitory computer-readable medium described herein, obtaining the information may include operations, features, means, or instructions for obtaining a first indication of the dictionary matrix and obtaining a second indication of a set of representation vectors, the set of representation vectors being based on the reference signal via the MIMO channel.

In some examples of the method, network entities, and non-transitory computer-readable medium described herein, the dictionary matrix includes a spatial domain dictionary matrix and a frequency domain dictionary matrix.

In some examples of the method, network entities, and non-transitory computer-readable medium described herein, obtaining the information associated with the dictionary matrix may include operations, features, means, or instructions for obtaining an indication of a representation vector, an indication of an updated dictionary matrix, an indication of an error matrix, an indication of a set of error vectors, or a combination thereof.

In some examples of the method, network entities, and non-transitory computer-readable medium described herein, the indication of the updated dictionary matrix may be transmitted in accordance with a first periodicity and the indication of the representation vector may be transmitted in accordance with a second periodicity and the second periodicity may be shorter than or equal to the first periodicity.

Some examples of the method, network entities, and non-transitory computer-readable medium described herein may further include operations, features, means, or instructions for outputting a signal indicating a configuration of a learning ratio, where the information associated with the dictionary matrix may be based on the learning ratio.

Some examples of the method, network entities, and non-transitory computer-readable medium described herein may further include operations, features, means, or instructions for precoding the reference signal based on the dictionary matrix, where the information associated with the dictionary matrix indicates a representation vector based on the reference signal.

In some examples of the method, network entities, and non-transitory computer-readable medium described herein, outputting the reference signal may include operations, features, means, or instructions for outputting a first reference signal from a first quantity of antenna ports, where obtaining the information includes obtaining an indication of an update of the dictionary matrix based on the first reference signal and outputting a second reference signal from a second quantity of one or more antenna ports that may be less than the first quantity of antenna ports, where obtaining the information includes obtaining information associated with a representative vector that may be based on the second reference signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports multiple-input and multiple-output (MIMO) channel feedback with dictionary learning in accordance with one or more aspects of the present disclosure.

FIG. 2 shows an example of a wireless communications system that supports MIMO channel feedback with dictionary learning in accordance with one or more aspects of the present disclosure.

FIG. 3 shows an example of components that support MIMO channel feedback with dictionary learning in accordance with one or more aspects of the present disclosure.

FIG. 4 shows an example of a process flow that supports MIMO channel feedback with dictionary learning in accordance with one or more aspects of the present disclosure.

FIGS. 5 and 6 show block diagrams of devices that support MIMO channel feedback with dictionary learning in accordance with one or more aspects of the present disclosure.

FIG. 7 shows a block diagram of a communications manager that supports MIMO channel feedback with dictionary learning in accordance with one or more aspects of the present disclosure.

FIG. 8 shows a diagram of a system including a device that supports MIMO channel feedback with dictionary learning in accordance with one or more aspects of the present disclosure.

FIGS. 9 and 10 show block diagrams of devices that support MIMO channel feedback with dictionary learning in accordance with one or more aspects of the present disclosure.

FIG. 11 shows a block diagram of a communications manager that supports MIMO channel feedback with dictionary learning in accordance with one or more aspects of the present disclosure.

FIG. 12 shows a diagram of a system including a device that supports MIMO channel feedback with dictionary learning in accordance with one or more aspects of the present disclosure.

FIGS. 13 through 16 show flowcharts illustrating methods that support MIMO channel feedback with dictionary learning in accordance with one or more aspects of the present disclosure.

### DETAILED DESCRIPTION

Some wireless communication devices utilize channel feedback to control signaling. For example, channel feedback may be utilized to control transmit power or allocate resources, such as time, frequency, or spatial resources. In some approaches, channel feedback may occupy a relatively large amount of channel resources. Compression may be utilized to reduce resource consumption or to send data more efficiently. Sparse representation of signals based on a dictionary may be used to compress transmission data to increase computational efficiency or communication resource utilization. A dictionary may be a set of elements (e.g., dictionary vectors or basis vectors, among other examples) that may be combined (e.g., linearly combined) to represent a signal.

In some approaches, a codebook may be designed to leverage a sparse representation of a precoding matrix in the spatial domain and the frequency domain. For example, fixed dictionaries of a two-dimensional (2D) discrete Fourier transform (DFT) in the spatial domain and a DFT in the frequency domain may be used, which may not guarantee optimality in terms of compression ratio or performance. In some approaches, a codebook may be utilized to apply frequency domain compression after finding a singular value decomposition (SVD) precoding matrix of a spatial domain-compressed channel. These approaches may utilize a relatively complicated SVD operation on the user equipment (UE) side, which may not be guaranteed to be optimal in terms of compression ratio. Moreover, phase errors, phase drifting, or a non-stationary multipath channel may occur between transceiver units (TXRUs), which may not be addressed with a fixed dictionary.

Some examples of the techniques described herein may provide multiple-input and multiple-output (MIMO) channel status feedback or channel state feedback (CSF) based on dictionary learning. An adaptive dictionary may provide an enhanced compression ratio for CSF information relative to a fixed dictionary. Various approaches for applying a sparse representation for CSF are provided herein. Techniques for applying dictionary learning for CSF procedures are also provided herein.

Sparse representation may be utilized in wireless communications. Sparse representation may include representing information with a reduced quantity of information. For example, a sparse representation of a signal based on dictionary learning may be utilized to compress transmission data with an adaptive basis to provide enhanced efficiency for computational or communication resource utilization. Sparse representation for signals may be achieved in accordance with the expression

$${min}_{D , X} \{ {‖ Y - DX ‖}_{F}^{2} \}$$

subject to ∀i, ∥xᵢ∥₀≤T₀, where D is an M×K overcomplete dictionary matrix that includes K basis vectors or dictionary vectors, Y denotes signal observations, X is a representation coefficient matrix, and T₀ is a threshold quantity of elements (e.g., basis vectors or dictionary vectors). For instance, Y may be represented with T₀ or fewer elements.

For adaptive dictionary design and sparse coding, some approaches may utilize an iterative procedure that alternates between sparse coding based on a current dictionary and an update procedure for the dictionary vectors to better fit the data. In some examples, sparse coding may be performed by computing the representation coefficients xᵢ based on a given signal yᵢ and the dictionary D. For instance, sparse coding may be achieved by using a pursuit procedure such as a matching pursuit procedure or an orthogonal matching pursuit procedure. Given a set

$$Y = {\{ {y}_{i} \}}_{i = 1}^{N} ,$$

a dictionary may be computed (e.g., adapted or updated) to provide improved representations for each member in the set with one or more sparsity constraints.

Adapting the dictionary may improve compression or performance for communicating signals via a MIMO channel. For example, a UE may utilize a learned dictionary to compress channel state information (e.g., a rank indicator (RI), channel quality indicator (CQI), precoding matrix indicator (PMI), other channel state information, or a combination thereof). For instance, a learned spatial domain dictionary and a learn frequency domain dictionary may be utilized to compress channel state information or other data for communication via a MIMO channel. The learned dictionary or dictionaries may provide increased compression for enhanced resource efficiency or more accurate representation of the compressed signal(s).

Aspects of the disclosure are initially described in the context of wireless communications systems. Aspects of the disclosure are also described in the context of a block diagram and a process flow diagram. Aspects of the disclosure are further illustrated by and described with reference to apparatus diagrams, system diagrams, and flowcharts that relate to MIMO channel feedback with dictionary learning.

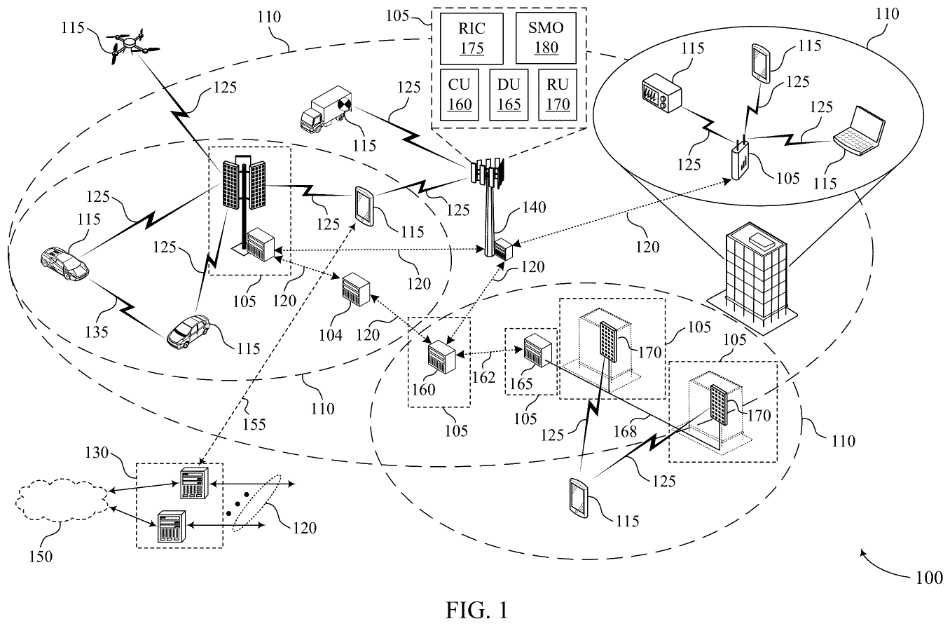

FIG. 1 shows an example of a wireless communications system 100 that supports MIMO channel feedback with dictionary learning in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported DFT size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication devices utilize channel feedback to control signaling. For example, channel feedback may be utilized to control transmit power or allocate resources, such as time, frequency, or spatial resources. In some approaches, channel feedback may occupy a relatively large amount of channel resources. Compression may be utilized to reduce resource consumption or to send data more efficiently. Sparse representation of signals based on a dictionary may be used to compress transmission data to increase computational efficiency or communication resource utilization. A dictionary may be a set of elements (e.g., dictionary vectors or basis vectors, among other examples) that may be combined (e.g., linearly combined) to represent a signal.

In some approaches, a codebook may be designed to leverage a sparse representation of a precoding matrix in the spatial domain and the frequency domain. For example, fixed dictionaries of a 2D DFT in the spatial domain and a DFT in the frequency domain may be used, which may not guarantee optimality in terms of compression ratio or performance. In some approaches, a codebook may be utilized to apply frequency domain compression after finding a SVD precoding matrix of a spatial domain-compressed channel. These approaches may utilize a relatively complicated SVD operation on the UE side, which may not be guaranteed to be optimal in terms of compression ratio. Moreover, phase errors, phase drifting, or a non-stationary multipath channel may occur between transceiver units, which may not be addressed with a fixed dictionary.

Some examples of the techniques described herein may provide MIMO CSF based on dictionary learning. An adaptive dictionary may provide an enhanced compression ratio for CSF information relative to a fixed dictionary. Various approaches for applying a sparse representation for CSF are provided herein. Techniques for applying dictionary learning for CSF procedures are also provided herein.

Sparse representation may be utilized in wireless communications. Sparse representation may include representing information with a reduced quantity of information. For example, a sparse representation of a signal based on dictionary learning may be utilized to compress transmission data with an adaptive basis to provide enhanced efficiency for computational or communication resource utilization. Sparse representation for signals may be achieved in accordance with the expression

$${min}_{D , X} \{ {‖ Y - DX ‖}_{F}^{2} \}$$

subject to ∀i, ∥xᵢ∥₀≤T₀, where D is an M×K overcomplete dictionary matrix that includes K basis vectors or dictionary vectors, Y denotes signal observations, X is a representation coefficient matrix, ∥ ∥_{F} denotes the Frobenius norm, and T₀ is a threshold quantity of elements (e.g., basis vectors or dictionary vectors). For instance, Y may be represented with T₀ or fewer elements.

For adaptive dictionary design and sparse coding, some approaches may utilize an iterative procedure that alternates between sparse coding based on a current dictionary and an update procedure for the dictionary vectors to better fit the data. In some examples, sparse coding may be performed by computing the representation coefficients xᵢ based on a given signal yᵢ and the dictionary D. For instance, sparse coding may be achieved by using a pursuit procedure such as a matching pursuit procedure or an orthogonal matching pursuit procedure. Some approaches for dictionary creation may utilize a set of signal observations (e.g., Y) to determine dictionary entries (e.g., vectors) that can be linearly combined to approximate the signal observations. For example, a dictionary may be initialized with entries (e.g., vectors) that are generated randomly or that are generated with one or more characteristics (e.g., varying periodicities, shapes, or amplitudes, among other examples). Entries in the dictionary may be searched to select an entry that best matches an observed signal (e.g., by taking an inner product between the observed signal and one or more of the entries). A difference between the selected entry and the observed signal may be computed. The selection procedure may iterate by finding an entry that best matches the difference, and so on, until an error threshold is met between a linear combination of the dictionary entries and the observed signal. The procedure may be performed with a sparsity constraint, which may limit the quantity of entries allowed for approximation. The dictionary entries may be adjusted to reduce the difference(s) between the observed signal and the selected entry(ies). For example, given a set

$$Y = {\{ {y}_{i} \}}_{i = 1}^{N} ,$$

a dictionary may be computed (e.g., adapted or updated) to provide improved representations for each member in the set with one or more sparsity constraints. Dictionary update procedures may further update the dictionary based on one or more additional signal observations over time, which may reduce the approximation error between the observed signal(s) and one or more dictionary entries.

Some examples of dictionary learning procedures are provided as follows. In a maximum likelihood (ML) approach, a dictionary D⁽ⁿ⁾ may be updated to D⁽ⁿ⁺¹⁾ in accordance with Equation (1).

$${D}^{( n + 1 )} = {D}^{( n )} - η {\sum }_{i = 1}^{N} ( {D}^{( n )} {x}_{i} - {y}_{i} ) {x}_{i}^{T} \qquad ( 1 )$$

In Equation (1), D⁽ⁿ⁾ is the dictionary, D⁽ⁿ⁺¹⁾ is the updated dictionary, n indicates an instance (e.g., a current instance value or index) of the dictionary, N is a quantity of signals or observations, η is a learning ratio, xᵢ are representation coefficients, yᵢ are signals, and T denotes a matrix transpose. A learning ratio may control a degree to which the dictionary is updated.

In a method of optimal directions (MOD) approach, the dictionary D⁽ⁿ⁾ may be updated to D⁽ⁿ⁺¹⁾ in accordance with Equation (2).

$${D}^{( n + 1 )} = {YX}^{{( n )}^{T}} \cdot {( {X}^{( n )} {X}^{{( n )}^{T}} )}^{- 1} \qquad ( 2 )$$

In Equation (2), D⁽ⁿ⁺¹⁾ is the updated dictionary, n is an instance (e.g., current instance value or index) of the dictionary, Y denotes signal observations, X is a representation coefficient matrix, and T denotes a matrix transpose.

In a maximum a posteriori (MAP) approach, the dictionary D⁽ⁿ⁾ may be updated to D⁽ⁿ⁺¹⁾ in accordance with Equation (3) without a constraint of a unit-norm column of D or in accordance with Equation (4) with a constraint of a unit-norm column of D.

$${D}^{( n + 1 )} = {D}^{( n )} + η {EX}^{T} + η \cdot tr ( X {E}^{T} {D}^{( n )} ) {D}^{( n )} \qquad ( 3 )$$

$${d}_{i}^{( n + 1 )} = {d}_{i}^{( n )} + η ( I - {d}_{i}^{( n )} {d}_{i}^{{( n )}^{T}} ) E \cdot {x}_{i}^{T} \qquad ( 4 )$$

In Equation (3) or Equation (4), D⁽ⁿ⁾ is the dictionary, D⁽ⁿ⁺¹⁾ is the updated dictionary, n indicates an instance (e.g., a current instance value or index) of the dictionary, E=[e₁, . . . , eₙ], with eᵢ=yᵢ−Dxᵢ with a signal yᵢ, η is a learning ratio, xᵢ is a representation coefficient with index i, X is a representation coefficient matrix, dᵢ is an element (e.g., vector) of the dictionary, tr( ) denotes the trace operation, I is the identity matrix, and T denotes a matrix transpose.

In some approaches, a union of orthonormal bases may be utilized for a pursuit algorithm. In some examples, D=[D₁, D₂, . . . , D_{L}], where Dⱼ, j=1, 2, . . . , L are orthonormal matrices, and X=[X₁, X₂, . . . , X_{L}]^{T}, where Xᵢ is a matrix that includes the coefficients of the dictionary Dᵢ. The update of Dᵢ=UV^{T}, where

$${E}_{j} {X}_{j}^{T} = U Λ {V}^{T}$$

(for an SVD, for instance) and Eⱼ=[e₁, e₂, . . . , eₙ]=Y−E_{i≠j}DᵢXᵢ.

Some approaches may utilize sparse representation for downlink CSF. For example, an Nt-port wideband channel state information reference signal (CSI-RS) may be transmitted, where the corresponding CSF may be based on spatial domain or frequency domain compression of channel estimates of the CSI-RS. For instance, a network entity 105 may use N₁× N₂ antenna to transmit an N-port wideband CSI-RS to a UE 115. The UE 115 may utilize the CSI-RS to generate CSF (e.g., a RI, CQI, or PMI) based on spatial domain or frequency domain compression of channel estimates. In some aspects, spatial domain compression with a 2D DFT basis may be utilized or frequency domain compression with a DFT basis may be utilized.

In an example, for each layer, the precoder across N₃ subbands may be expressed as W=W₁×\tilde{W}₂×W_{f}*, where the superscript * denotes the conjugate transpose or Hermitian transpose. The UE 115 may utilize the CSI-RS to determine a channel estimate (e.g., channel matrix H) to determine a spatial domain or frequency domain basis and coefficients. If each row of the channel matrix H can be spanned by L orthogonal basis vectors

$$\{ {b}_{0}^{H} , … , {b}_{L - 1}^{H} \} \to H \approx C {B}^{H} ,$$

where B=[b₀, . . . , b_{L-1}], and

$$C = {U}_{c} {\sum }_{c} {V}_{c} \to H = {U}_{c} {\sum }_{c} {V}_{c}^{H} {B}^{H} \to {V}_{c}^{( R )} B$$

is the SVD precoding matrix, implying that B is a spatial domain basis W₁ or V_{c}^{(R)} is compressed with a frequency domain basis. The L spatial domain basis vectors may be determined (e.g., in accordance with

$$arg {max}_{{i}_{0} , … {i}_{L - 1}} {\sum }_{l = 0}^{L - 1} {\vert {Hb}_{{i}_{l}} \vert}^{2} ) ,$$

and the SVD precoding matrix of C(f) may be determined

$$( e . g . , {V}_{c}^{( R )} ( f )$$

for each subband f may imply frequency domain compression with a DFT basis).

The UE 115 may transmit the CSF to the network entity 105, which may decompress the CSF. The network entity 105 may utilize the CSF to perform precoding, power control, or resource allocation (e.g., time resource allocation, frequency resource allocation, or rank selection, among other examples) for one or more communications with the UE 115.

Adapting the dictionary may improve compression or performance for communicating signals via a MIMO channel. For example, a UE 115 may utilize a learned dictionary to compress channel state information (e.g., an RI, CQI, PMI, other channel state information, or a combination thereof). For instance, a learned spatial domain dictionary and a learned frequency domain dictionary may be utilized to compress channel state information or other data for communication via a MIMO channel. The learned dictionary or dictionaries may provide increased compression for enhanced resource efficiency or more accurate representation of the compressed signal(s).

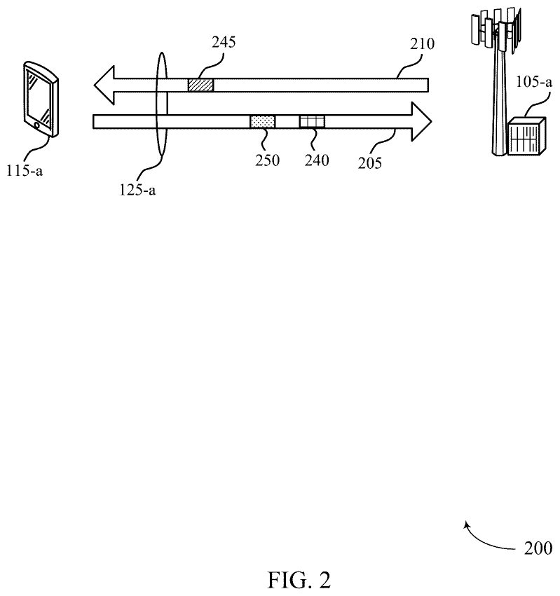

FIG. 2 shows an example of a wireless communications system 200 that supports MIMO channel feedback with dictionary learning in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a communication link 125-a, which may be an example of a communication link 125 described with respect to FIG. 1. The communication link 125-a may include a bi-directional link that enables uplink or downlink network communications. For example, the UE 115-a may transmit one or more uplink transmissions 205, such as uplink control signals or uplink data signals, to the network entity 105-a using the communication link 125-a, or the network entity 105-a may transmit one or more downlink transmissions 210, such as downlink control signals or downlink data signals, to the UE 115-a using the communication link 125-a.

The network entity 105-a may output (e.g., transmit), or the UE 115-a may receive, a reference signal 245 via a MIMO channel. For instance, the network entity 105-a may utilize multiple antennas to transmit the reference signal 245, or the UE 115-a may utilize multiple antennas to receive the reference signal 245. The reference signal 245 may be a signal with one or more established properties (e.g., frequency, amplitude, timing, phase, modulation, or information sequence, among other examples). In some examples, the reference signal 245 may be a CSI-RS, a demodulation reference signal (DMRS), a tracking reference signal (TRS), or another reference signal.

In some examples, the UE 115-a may generate an estimate of the MIMO channel based on the reference signal 245. For instance, the UE 115-a may determine a difference between the receive reference signal 245 and an established reference signal (e.g., a predefined reference signal with one or more established properties) to determine the estimate of the MIMO channel. In some aspects, the estimate of the MIMO channel may be expressed as a channel matrix H, where elements (e.g., h) of the channel matrix may represent channel components of the MIMO channel for respective antennas. For each receive antenna, for example, the UE 115-a may utilize the reference signal 245 (e.g., CSI-RS tones) to estimate the channel {h₁, . . . , hₘ}, which may be utilized for sparse coding or dictionary learning for a spatial channel.

The UE 115-a may determine information 240 associated with a dictionary matrix based on the estimate of the MIMO channel. The information 240 may be based on the reference signal 245 via the MIMO channel. For example, the UE 115-a may generate a dictionary matrix or may update a dictionary matrix to determine the information 240. In some aspects, the UE 115-a may perform one or more of the procedures described with reference to FIG. 1 (e.g., Equation (1), Equation (2), Equation (3), or Equation (4)) to update the dictionary matrix.

The information 240 may be associated with the dictionary matrix for CSF compression. For instance, the UE 115-a may utilize the dictionary matrix for CSF compression. In some examples, the UE 115-a may determine the CSF (e.g., CQI, PMI, RI, or other feedback information related to the MIMO channel) based on the reference signal 245 and may utilize the dictionary matrix or the information 240 to perform compression on the CSF. The information 240 may be information that may enable another device (e.g., the network entity 105-a) to decompress the compressed CSF (e.g., to update a dictionary matrix for CSF decompression).

In some examples, the information 240 may include an indication of one or more dictionary matrices, an indication of one or more representation vectors (e.g., a set of representation vectors based on a gram matrix of the estimate of the MIMO channel), a spatial domain dictionary matrix, a frequency domain dictionary matrix, an indication of an updated dictionary matrix, an indication of an error matrix, or a combination thereof. Additional detail regarding the information 240 is given with reference to one or more examples provided herein.

The UE 115-a may transmit, or the network entity 105-a may obtain (e.g., receive), the information 240 associated with the dictionary matrix. For instance, the dictionary matrix may be utilized for CSF compression (by the UE 115-a, for example) or CSF decompression (by the network entity 105-a, for example).

The UE 115-a or the network entity 105-a may communicate (e.g., may transmit or receive) data 250 via the MIMO channel. The data 250 may be processed based on the dictionary matrix. In some examples, the data 250 may include compressed CSF produced based on the dictionary matrix. Additionally, or alternatively, the data 250 may include other information that is transmitted based on the dictionary matrix. For instance, the data 250 may include information that is precoded based on a PMI that is compressed or decompressed based on the dictionary matrix, information that is transmitted via resources determined based on a CQI that is compressed or decompressed based on the dictionary matrix, or information that is transmitted via one or more layers based on an RI that is compressed or decompressed based on the dictionary matrix.

In some examples, communicating (e.g., transmitting or obtaining) the information 240 may include communicating a first indication of the dictionary matrix or communicating a second indication of a set of representation vectors, where the set of representation vectors is based on the reference signal 245 or the estimate of the MIMO channel. For instance, the first indication of the dictionary matrix may be an indication of one or more dictionary matrices.

In some aspects, the UE 115-a may report a spatial domain dictionary matrix (e.g., Dₛ) or a frequency domain dictionary matrix (e.g., D_{f}). In some codebook variations, the UE 115-a may compress the CSF based on the spatial domain dictionary matrix or the frequency domain dictionary matrix. For instance, the UE 115-a may perform spatial domain compression in accordance with

$$H ( f ) \approx C ( f ) {D}_{s}^{H} ( K ≪ {N}_{t} ) ,$$

where the channel matrix H(f) has dimensions of a quantity of receive antennas (Nᵣ) by a quantity of transmit antennas (Nₜ) (e.g., Nᵣ×Nₜ), C(f) has dimensions of a quantity of receive antennas by K (e.g., Nᵣ×K), and D″ has dimensions of K by a quantity of transmit antennas (e.g., K×Nₜ). Additionally, or alternatively, the UE 115-a may perform frequency domain compression in accordance with [c_{n,k}(1), . . . c_{n,k}(N₃)]^{T}≈D_{f} [w_{n,k}(1), . . . w_{n,k}(M)]^{T} (M<<N₃), for n=1, . . . , Nᵣ, k=1, . . . , K, where c_{n,k} are elements of the matrix C(f), and where w_{n,k} are coefficient vectors of the channel matrix H(f).

In some aspects, the UE 115-a may transmit (e.g., report) the second indication of a set of representation vectors. For instance, the set of representation vectors may be a set of coefficient vectors ([w_{n,k}(1), . . . , w_{n,k}(M)]^{T}) of the channel matrix.

In some examples, the set of representation vectors may be based on a gram matrix of the estimate of the MIMO channel. For instance, transmitting the information 240 may include transmitting a first indication of the dictionary matrix or transmitting a second indication of a set of representation vectors, where the set of representation vectors is based on a gram matrix of the estimate of the MIMO channel.

In some aspects, the UE 115-a may report a spatial domain dictionary matrix (e.g., Dₛ) or a frequency domain dictionary matrix (e.g., D_{f}). In some codebook variations, the UE 115-a may compress the CSF based on the spatial domain dictionary matrix or the frequency domain dictionary matrix. For instance, the UE 115-a may perform spatial domain compression in accordance with

$$H {( f )}^{H} H ( f ) \approx {D}_{s} {C ( f )}^{H} C ( f ) {D}_{s}^{H} \to G ( f ) = {C ( f )}^{H} C ( f ) .$$

Additionally, or alternatively, the UE 115-a may perform frequency domain compression in accordance with [g_{i,j}(1), . . . g_{i,j}(N₃)]^{T}≈D_{f} [v_{i,j}(1), . . . v_{i,j}(M)]^{T} (M<<N₃), for i=1, . . . , K, j=1, . . . , K, where g_{n,k}(f) are the elements of G(f) and v_{i,j} are coefficient vectors of the gram matrix of the channel matrix.

In some aspects, the UE 115-a may transmit (e.g., report) the second indication of a set of representation vectors. For instance, the set of representation vectors may be a set of coefficient vectors ([v_{i,j}(1), . . . v_{i,j}(M)]′) of the gram matrix of the channel matrix.

In some examples, the first indication of the dictionary matrix is transmitted in accordance with a first periodicity and the second indication of the set of representation vectors is transmitted in accordance with a second periodicity, where the second periodicity is shorter than or equal to the first periodicity. For instance, the second indication (e.g., the coefficient vectors [w_{n,k}(1), . . . w_{n,k}(M)]^{T} or the coefficient vectors [v_{i,j}(1), . . . v_{i,j}(M)]′) may be reported more frequently (e.g., short-term) while spatial domain dictionary matrix or frequency domain dictionary matrix (e.g., spatial domain or frequency domain bases) may be reported less frequently (e.g., long-term). Communicating one or more second indications of the set of representation vectors (e.g., coefficient vectors) may be utilized to update the dictionary matrix at the network entity 105-a between first indications of the dictionary matrix. Because communicating the first indication of the dictionary matrix may consume more resources than the second indication of the set of representation vectors, transmitting the second indication more frequently than the first indication may reduce resource consumption.

In some approaches, the UE 115-a may perform spatial compression based on dictionary learning. For instance, the reference signal 245 (e.g., CSI-RS tones) may be utilized for sparse coding or dictionary learning for a spatial channel. In some aspects, the UE 115-a may, for one or more receive antennas, estimate the channel (e.g., {h₁, . . . hₘ}) to determine an indication of one or more representation vectors (e.g., {β₁, . . . β_{M}} based on a spatial domain dictionary (e.g., Dₛ⁽ⁿ⁾). For instance, hₘ may be an Nt×1 spatial channel on the m-th subband or βₘ may be a K×1 sparse representation on the m-th subband. The set of representation vectors may be utilized to update the spatial domain dictionary (e.g., update to

$${D}_{s}^{( n + 1 )} ) .$$

In some examples, transmitting the information 240 associated with the dictionary matrix may include transmitting an indication of a representation vector (e.g., sparse representation vector(s) {β₁, . . . β_{M}}), an indication of an updated dictionary matrix, an indication of an error matrix (e.g., spatial error matrix or frequency error matrix), an indication of a set of error vectors (e.g., spatial error vectors or frequency error vectors), or a combination thereof. For instance, the UE 115-a may report an indication of one or more of the following (e.g., information for updating a dictionary for CSF compression or decompression): an updated dictionary D⁽ⁿ⁺¹⁾, an error matrix

$${\sum }_{m = 1}^{M} ( {D}_{s}^{( n )} {β}_{m} - {h}_{m} ) {β}_{m}^{T}$$

or spatial error vectors, or a combination thereof. The channel eₘ=D⁽ⁿ⁾βₘ−hₘ (for m=1, . . . , M) or spatial error vectors, or a combination thereof. The channel {h₁, . . . h_{M}} may be input to the spatial domain dictionary

$${D}_{s}^{( n )}$$

to generate the sparse representation vectors {β₁, . . . β_{M}}. In some approaches, the UE 115-a or the network entity 105-a may update the dictionary in accordance with

$${D}_{s}^{( n + 1 )} = {D}_{s}^{( n )} - η {\sum }_{m = 1}^{M} ( {D}_{s}^{( n )} {β}_{m} - {h}_{m} ) {β}_{m}^{T} .$$

In some examples, an initial or default dictionary (e.g., D⁽⁰⁾) may be utilized by the UE 115-a or the network entity 105-a. For instance, D⁽⁰⁾ may be a default dictionary that is specified (e.g., predefined) or may be indicated via signaling from the network entity 105-a to the UE 115-a or from the UE 115-a to the network entity 105-a. In some examples, D⁽⁰⁾ may be a 2D-DFT dictionary.

In some aspects, the network entity 105-a may transmit, or the UE 115-a may receive, a signal indicating a configuration of a learning ratio (e.g., η). The information 240 associated with the dictionary matrix may be based on the learning ratio. For instance, the information 240 may be determined utilizing η as described herein. In some examples, the learning ratio may be configured via RRC signaling (e.g., configured on the UE 115-a via RRC signaling from the network entity 105-a).

In some approaches, the indication of the updated dictionary matrix may be transmitted in accordance with a first periodicity and the indication of the representation vector may be transmitted in accordance with a second periodicity. The second periodicity may be shorter than or equal to the first periodicity. For example, reporting periods of the sparse representation and the dictionary update may be different from each other (e.g., the sparse representation may be reported more frequently or with a short period, while the dictionary update may be reported less frequently or with long period). Communicating one or more indications of the representation vector may be utilized to update the dictionary matrix at the network entity 105-a between indications of the updated dictionary matrix. Because communicating the indication of the updated dictionary matrix may consume more resources than the indication of the representation vector, transmitting the indication of the representation vector more frequently than the indication of the updated dictionary matrix may reduce resource consumption.

In some approaches, the UE 115-a may perform frequency domain compression. In some aspects, the spatial domain compressed channel may be further compressed with frequency domain dictionary learning. For instance, the spatial domain compressed channel (e.g., {β₁, . . . β_{K}}) may be utilized to determine an indication of one or more representation vectors (e.g., {γ₁, . . . γ_{K}} based on a frequency domain dictionary

$$( e . g . , {D}_{f}^{( n )} ) .$$

For instance, βₖ may be an S-tuple frequency domain channel vector for the k-th layer or γₖ may be Q-tuple sparse representation vector for the k-th layer. The set of representation vectors may be utilized to update the frequency domain dictionary (e.g., update to

$${D}_{f}^{( n + 1 )} ) .$$

In some examples, transmitting the information 240 associated with the dictionary matrix may include transmitting an indication of a representation vector (e.g., sparse representation vector(s) {γ₁, . . . γ_{K}}), an indication of an updated dictionary matrix, an indication of an error matrix, an indication of a set of error vectors, or a combination thereof. For instance, the UE 115-a may report an indication of one or more of the following (e.g., information for updating a dictionary for CSF compression or decompression): one or more updated dictionaries

$$( e . g . , {D}_{f}^{( n + 1 )} or {D}_{s}^{( n + 1 )} ) ,$$

an error matrix

$${\sum }_{m = 1}^{K} ( {D}_{f}^{( n )} {γ}_{m} - {β}_{m} ) {γ}_{m}^{T}$$

(in addition to, or alternatively from, the spatial error matrix), error vectors

$${f}_{m} = ( {D}_{f}^{( n )} {γ}_{m} - {β}_{m} )$$

(for m=1, . . . , K) (in addition to, or alternatively from, the spatial error vectors), or a combination thereof. The channel {h^{<1>}, . . . h^{<N>}} may be input to the spatial domain dictionary

$${D}_{s}^{( n )}$$

to generate the sparse representation vectors {β₁, . . . β_{K}} (or the update the spatial domain dictionary

$${D}_{s}^{( n )} \to {D}_{s}^{( n + 1 )} ) ,$$

which sparse representation vectors {β₁, . . . β_{K}} may be input to the frequency domain dictionary

$${D}_{f}^{( n )}$$

to produce the sparse representation vectors {γ₁, . . . γ_{K}}. In some approaches, the UE 115-a or the network entity 105-a may update the dictionary in accordance with

$${D}_{f}^{( n + 1 )} = {D}_{f}^{( n )} - {η}_{f} {\sum }_{m = 1}^{K} ( {D}_{f}^{( n )} {γ}_{m} - {β}_{m} ) {γ}_{m}^{T} .$$

In some examples, an initial or default frequency domain dictionary

$$( e . g . , {D}_{f}^{( 0 )} )$$

may be utilized by the UE 115-a or the network entity 105-a. For instance,

$${D}_{f}^{( 0 )}$$

may be a default frequency domain dictionary that is specified (e.g., predefined) or may be indicated via signaling from the network entity 105-a to the UE 115-a or from the UE 115-a to the network entity 105-a. In some examples,

$${D}_{f}^{( 0 )}$$

may be a DFT matrix.

In some aspects, the network entity 105-a may transmit, or the UE 115-a may receive, a signal indicating a configuration of a frequency domain learning ratio (e.g., a learning ratio η_{f} for the frequency domain that may be same as or different from the learning ratio utilized for spatial domain compression). The information 240 associated with the dictionary matrix may be based on the frequency domain learning ratio. For instance, the information 240 may be determined utilizing η_{f} as described herein. In some examples, the frequency domain learning ratio may be configured via RRC signaling (e.g., configured on the UE 115-a via RRC signaling from the network entity 105-a).

In some approaches, reporting periods for sparse representation, spatial dictionary update, or frequency dictionary update may be the same as each other or different from each other. For instance, sparse representation(s), spatial dictionary update(s), or frequency dictionary update(s) may be communicated in accordance with a first periodicity, a second periodicity, or a third periodicity.

In some examples, dictionary learning may be performed with cooperation between the network entity 105-a and the UE 115-a. For example, sparse coding may be performed on the UE 115-a, while dictionary learning may be performed on the network entity 105-a. The dictionary may be relatively insensitive to short-term channel variations while sparse representation is determined. In some cases, a quantity of transceiver units is equal to a quantity of ports (e.g., N) for the reference signal 245 (e.g., CSI-RS ports). For instance, N=256 or more for some implementations. If the network entity 105-a has stored the sparse dictionary (e.g., h≈Dβ), a K-port reference signal (e.g., CSI-RS) may be sufficient (e.g., K<<N) for dictionary learning.

In some approaches, the reference signal 245 may be precoded based on the dictionary matrix. For instance, the network entity 105-a may transmit, or the UE 115-a may receive, CSI-RS precoded with D⁽ⁿ⁾^{^{H}} (e.g., a K-port CSI-RS precoded with D⁽ⁿ⁾^{^{H}}). The UE 115-a may estimate a representation vector (e.g., β) based on the estimate of the MIMO channel. Based on a K-port CSI-RS precoded with D^{H}, for example, the UE 115-a may estimate D^{H}h≈β.

The information 240 associated with the dictionary matrix may indicate the representation vector (e.g., β). For instance, the UE 115-a may calculate and report (e.g., feedback) β to the network entity 105-a.

The network entity 105-a may update the dictionary. For instance, the network entity 105-a may update D⁽ⁿ⁾ to D⁽ⁿ⁺¹⁾. In some ML approaches, the network entity 105-a may update the dictionary in accordance with

$${D}^{( n + 1 )} = {D}^{( n )} - η {\sum }_{m = 1}^{K} ( {D}^{( n )} {β}_{m} - {h}_{m} ) {β}_{m}^{T} .$$

In some examples, the network entity 105-a may determine a channel estimate (e.g., hₘ) from a reference signal (not shown in FIG. 2) from the UE 115-a. For instance, the UE 115-a may transmit, or the network entity 105-a may receive, a sounding reference signal (SRS), which the network entity 105-a may utilize to update the dictionary. In some MOD approaches, the network entity 105-a may update the dictionary in accordance with D⁽ⁿ⁺¹⁾=HB^{H}(BB^{H})⁻¹, where H=[h₁, . . . , h_{M}] and B=[β₁, . . . , β_{M}].

In some approaches, dictionary learning may be performed with multiple (e.g., two) types of reference signals (e.g., CSI-RS). For instance, communicating (e.g., transmitting or receiving) the reference signal 245 may include receiving a first reference signal that is transmitted from a first quantity of antenna ports or receiving a second reference signal that is transmitted from a second quantity of one or more antenna ports that is less than the first quantity of antenna ports. In some aspects, the first reference signal may be a first type of CSI-RS (e.g., type-1 CSI-RS). For instance, the first reference signal may be an N-port CSI-RS that may be utilized to update the dictionary. In some aspects, the network entity 105-a my transmit the type-1 N-port CSI-RS to the UE 115-a, and the UE 115-a may utilize the type-1 N-port CSI-RS to perform sparse coding and dictionary learning, and to feedback D⁽ⁿ⁺¹⁾ or β.

In some approaches, the first reference signal may be utilized to update the dictionary relatively less frequently (e.g., with a longer period or in an aperiodic manner). In some aspects, the second reference signal may be a second type of CSI-RS (e.g., type-2 CSI-RS). For instance, the second reference signal may be a K-port CSI-RS that may be utilized for CSI acquisition (e.g., K<<N or the CSI-RS may be precoded with D^{H}).

In some examples, transmitting the information 240 may include transmitting an indication of an update of the dictionary matrix based on the first reference signal. For instance, for type-1 CSI-RS, the UE 115-a may perform the dictionary update (e.g., may update D⁽ⁿ⁾ to D⁽ⁿ⁺¹⁾. In some approaches, the UE 115-a may estimate the channel (e.g., h), which may be utilized to calculate a representative vector (e.g., β), which may be utilized to update or report D or β. In some approaches, β≈D^{H}h.

In some examples, transmitting the information 240 may include transmitting information associated with a representative vector that is based on the second reference signal. For type-2 CSI-RS, for instance, the UE 115-a may estimate or report β. In some aspects, the UE 115-a may perform explicit β reporting. Additionally, or alternatively, UE 115-a may determine or report CSF (e.g., RI, PMI, or CQI, among other examples) based on updated codebook for β. In some aspects, the network entity 105-a my transmit the type-2 K-port CSI-RS to the UE 115-a, and the UE 115-a may utilize the type-2 K-port CSI-RS to perform CSI feedback or to feedback β.

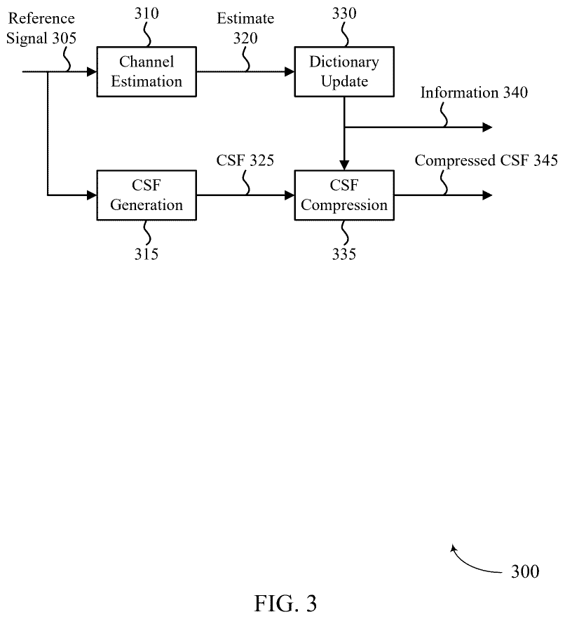

FIG. 3 shows examples of components 300 that support MIMO channel feedback with dictionary learning in accordance with one or more aspects of the present disclosure. One or more of the components 300 may be implemented in hardware (e.g., circuitry) or a combination of hardware and instructions (e.g., a processor with instructions). The components 300 may include a channel estimation component 310, a dictionary update component 330, a CSF generation component 315, or a CSF compression component 335. One or more of the components 300 may be divided into multiple components, or two or more of the components 300 may be combined into one component. In some examples, one or more of the UE 115-a or the network entity 105-a may include or implement one or more of the components 300. In some aspects, the wireless communications system 100 or the wireless communications system 200 may operate in accordance with one or more aspects of one or more of the components 300.

A reference signal 305 may be provided to the channel estimation component 310 or to the CSF generation component 315. For instance, the UE 115-a may receive a reference signal 305 as described with reference to FIG. 2.

The channel estimation component 310 may generate a channel estimate 320 based on the reference signal 305. For instance, the UE 115-a may generate a channel estimate 320 as described with reference to FIG. 2. The channel estimate 320 may be provided to the dictionary update component 330.

The dictionary update component 330 may update a dictionary based on the channel estimate 320. For instance, the UE 115-a may update the dictionary D⁽ⁿ⁾ to D⁽ⁿ⁺¹⁾ based on the channel estimate 320 (e.g., H or h), as described with reference to FIG. 2. The dictionary update component 330 may generate information 340. For instance, the information 340 may be an example of the information 240 described with reference to FIG. 2. In some examples, the information 340 may include an indication of the updated dictionary matrix, an indication of an error matrix (e.g., spatial error matrix or frequency error matrix), an indication of a set of error vectors (e.g., spatial error vectors or frequency error vectors), one or more representation vectors, or a combination thereof. The information 340 may be transmitted (e.g., transmitted to the network entity 105-a) or provided to the CSF compression component 335.

The CSF generation component 315 may generate CSF 325 based on the reference signal 305. For instance, the CSF generation component 315 may generate a PMI, a CQI, an RI, or other CSF as described with reference to FIG. 2. The CSF 325 may be provided to the CSF compression component 335.

The CSF compression component 335 may perform compression on the CSF based on the information 340 (e.g., updated dictionary) to generate compressed CSF 345. For instance, the CSF compression component 335 may perform spatial domain compression, frequency domain compression, or a combination thereof as described with reference to FIG. 2. In some approaches, the CSF compression component 335 may utilize a dictionary (e.g., the updated dictionary) to determine a linear combination of vectors from the dictionary that represents the CSF 325. The compressed CSF 345 may be an indication (e.g., indices) of the determined vectors. The compressed CSF 345 may be transmitted (e.g., transmitted to the network entity 105-a).

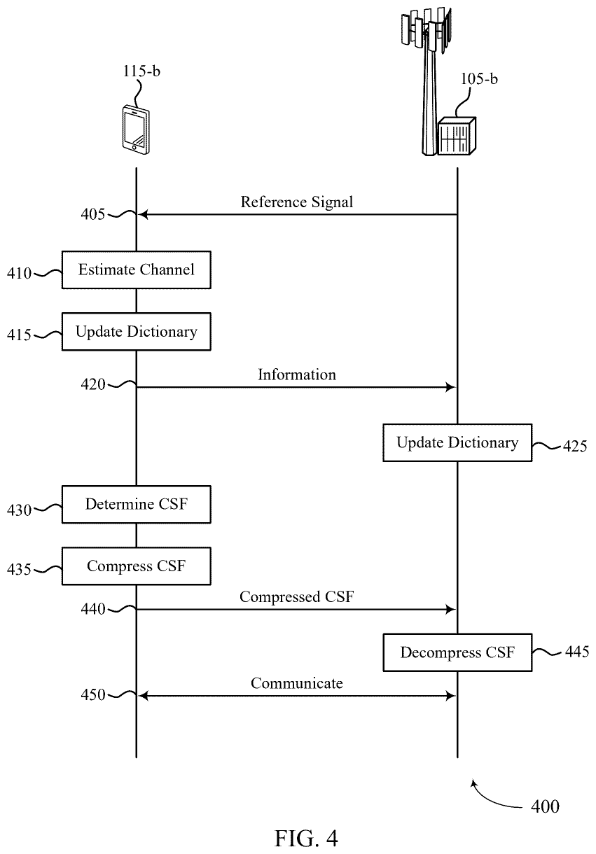

FIG. 4 shows an example of a process flow 400 that supports MIMO channel feedback with dictionary learning in accordance with one or more aspects of the present disclosure. A wireless communication system may include a UE 115-b and a network entity 105-b. The UE 115-b may be an example of the UEs 115 or the UE 115-a, or the network entity 105-b may be an example of the network entities 105 or the network entity 105-a, as described herein.

In the following description of the process flow 400, the communications between the network entity 105-b and the UE 115-b may be transmitted in a different order than the example order shown, or the operations performed by the network entity 105-b and the UE 115-b may be performed in different orders or at different times. Some operations may be omitted from the process flow 400, or other operations may be added to the process flow 400. Although some operations or signaling may be shown to occur at different times for discussion purposes, these operations may actually occur at the same time or in overlapping time periods in some examples.

At 405, the network entity 105-b may output, or the UE 115-b may receive, a reference signal 405. For example, the UE 115-b may receive a CSI-RS as described with reference to FIG. 2 or FIG. 3.

At 410, the UE 115-b may estimate a channel. For example, the UE 115-b may estimate H or h as described with reference to FIG. 2 or FIG. 3.

At 415, the UE 115-b may update a dictionary. For example, the UE 115-b may update a dictionary D⁽ⁿ⁾ to D⁽ⁿ⁺¹⁾ based on the estimate as described with reference to FIG. 2 or FIG. 3.

At 420, the UE 115-b may transmit information to the network entity 105-b. The information may include one or more indicators that may be utilized to update a dictionary. For instance, the information may include an indication of the updated dictionary matrix, an indication of an error matrix (e.g., spatial error matrix or frequency error matrix), an indication of a set of error vectors (e.g., spatial error vectors or frequency error vectors), one or more representation vectors, or a combination thereof as described with reference to FIG. 2 or FIG. 3.

At 425, the network entity 105-b may update the dictionary based on the information. For example, the network entity 105-b may update a dictionary D⁽ⁿ⁾ to D⁽ⁿ⁺¹⁾ based on the information as described with reference to FIG. 2 or FIG. 3.

At 430, the UE 115-b may determine CSF. For instance, the UE 115-b may determine PMI, CQI, or RI as described with reference to FIG. 2 or FIG. 3.

At 435, the UE 115-b may compress CSF. For instance, the UE 115-b may compress the PMI, CQI, or RI as described with reference to FIG. 2 or FIG. 3.

At 440, the UE 115-b may transmit the compressed CSF to the network entity 105-b. For instance, the UE 115-b may transmit the compressed PMI, CQI, or RI as described with reference to FIG. 2 or FIG. 3.

At 445, the network entity 105-b may decompress the CSF. For instance, the network entity 105-b may utilize the compressed CSF and the dictionary to determine a PMI, CQI, or RI (e.g., use indices indicated by the compressed CSF to determine a linear combination of the entries in the dictionary indicating the decompressed CSF) based on the compressed CSF.

At 450, the UE 115-b or the network entity 105-b may communicate based on the CSF. For instance, the network entity 105-b may perform precoding based on the decompressed PMI or may send one or more signals based on the decompressed CSF.

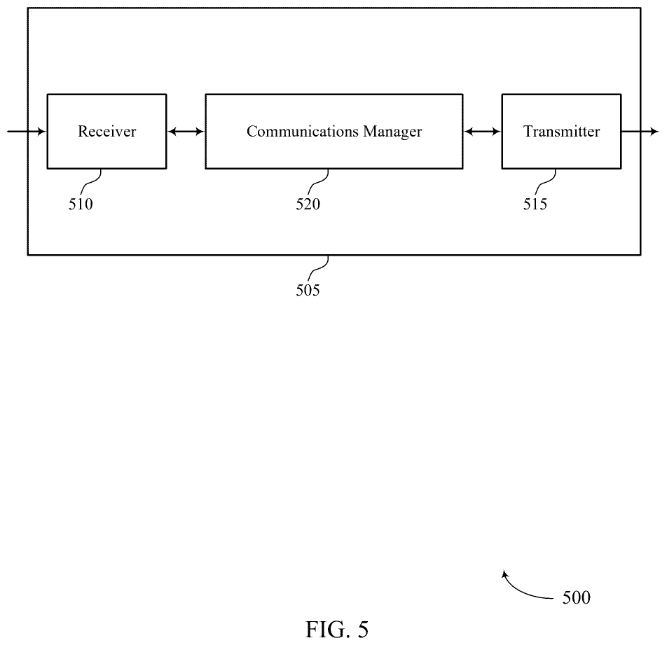

FIG. 5 shows a block diagram 500 of a device 505 that supports MIMO channel feedback with dictionary learning in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to MIMO channel feedback with dictionary learning). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to MIMO channel feedback with dictionary learning). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of MIMO channel feedback with dictionary learning as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a reference signal from a network entity via a multiple-input and multiple-output (MIMO) channel, where an estimate of the MIMO channel is generated based on the reference signal. The communications manager 520 is capable of, configured to, or operable to support a means for transmitting information associated with a dictionary matrix for CSF compression, where the information is based on the estimate of the MIMO channel. The communications manager 520 is capable of, configured to, or operable to support a means for communicating data via the MIMO channel, where the data is processed based on the dictionary matrix.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, or more efficient utilization of communication resources.

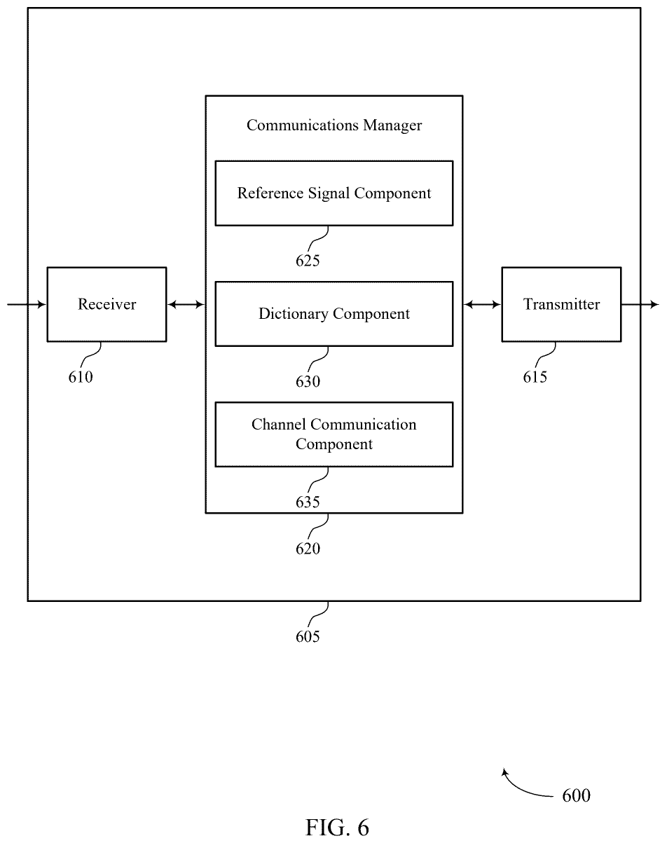

FIG. 6 shows a block diagram 600 of a device 605 that supports MIMO channel feedback with dictionary learning in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to MIMO channel feedback with dictionary learning). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to MIMO channel feedback with dictionary learning). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of MIMO channel feedback with dictionary learning as described herein. For example, the communications manager 620 may include a reference signal component 625, a dictionary component 630, a channel communication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The reference signal component 625 is capable of, configured to, or operable to support a means for receiving a reference signal from a network entity via a MIMO channel, where an estimate of the MIMO channel is generated based on the reference signal. The dictionary component 630 is capable of, configured to, or operable to support a means for transmitting information associated with a dictionary matrix for CSF compression, where the information is based on the estimate of the MIMO channel. The channel communication component 635 is capable of, configured to, or operable to support a means for communicating data via the MIMO channel, where the data is processed based on the dictionary matrix.

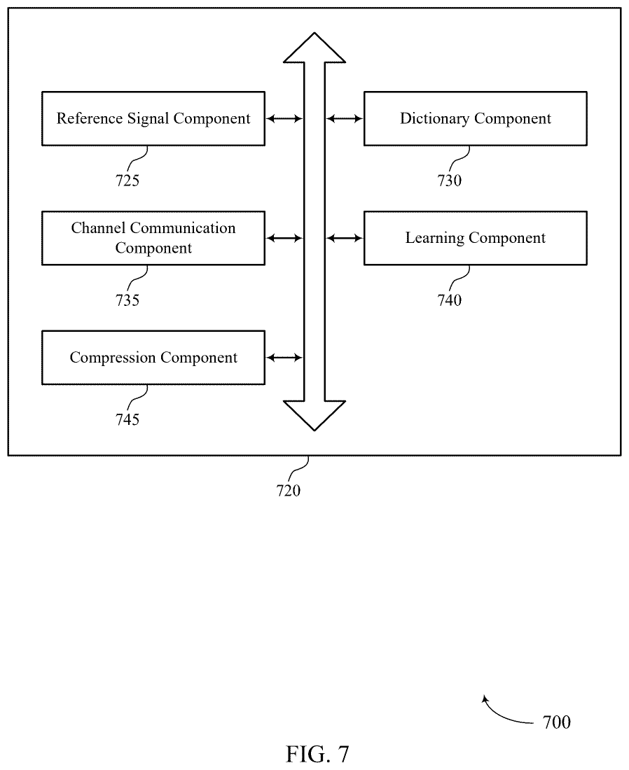

FIG. 7 shows a block diagram 700 of a communications manager 720 that supports MIMO channel feedback with dictionary learning in accordance with one or more aspects of the present disclosure. The communications manager 720 may be an example of aspects of a communications manager 520, a communications manager 620, or both, as described herein. The communications manager 720, or various components thereof, may be an example of means for performing various aspects of MIMO channel feedback with dictionary learning as described herein. For example, the communications manager 720 may include a reference signal component 725, a dictionary component 730, a channel communication component 735, a learning component 740, a compression component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The reference signal component 725 is capable of, configured to, or operable to support a means for receiving a reference signal from a network entity via a MIMO channel, where an estimate of the MIMO channel is generated based on the reference signal. The dictionary component 730 is capable of, configured to, or operable to support a means for transmitting information associated with a dictionary matrix for CSF compression, where the information is based on the estimate of the MIMO channel. The channel communication component 735 is capable of, configured to, or operable to support a means for communicating data via the MIMO channel, where the data is processed based on the dictionary matrix.

In some examples, to support transmitting the information, the dictionary component 730 is capable of, configured to, or operable to support a means for transmitting a first indication of the dictionary matrix. In some examples, to support transmitting the information, the dictionary component 730 is capable of, configured to, or operable to support a means for transmitting a second indication of a set of representation vectors, the set of representation vectors being based on the estimate of the MIMO channel.

In some examples, the set of representation vectors is based on a gram matrix of the estimate of the MIMO channel.

In some examples, the first indication of the dictionary matrix is transmitted in accordance with a first periodicity and the second indication of the set of representation vectors is transmitted in accordance with a second periodicity. In some examples, the second periodicity is shorter than or equal to the first periodicity.

In some examples, the dictionary matrix includes a spatial domain dictionary matrix and a frequency domain dictionary matrix.

In some examples, the compression component 745 is capable of, configured to, or operable to support a means for compressing the CSF based on the spatial domain dictionary matrix and the frequency domain dictionary matrix.

In some examples, to support transmitting the information associated with the dictionary matrix, the dictionary component 730 is capable of, configured to, or operable to support a means for transmitting an indication of a representation vector, an indication of an updated dictionary matrix, an indication of an error matrix, an indication of a set of error vectors, or a combination thereof.

In some examples, the indication of the updated dictionary matrix is transmitted in accordance with a first periodicity and the indication of the representation vector is transmitted in accordance with a second periodicity. In some examples, the second periodicity is shorter than or equal to the first periodicity.

In some examples, the learning component 740 is capable of, configured to, or operable to support a means for receiving a signal indicating a configuration of a learning ratio, where the information associated with the dictionary matrix is based on the learning ratio.

In some examples, the reference signal is precoded based on the dictionary matrix, and the dictionary component 730 is capable of, configured to, or operable to support a means for estimating a representation vector based on the estimate of the MIMO channel, where the information associated with the dictionary matrix indicates the representation vector.

In some examples, to support receiving the reference signal, the reference signal component 725 is capable of, configured to, or operable to support a means for receiving a first reference signal that is transmitted from a first quantity of antenna ports, where transmitting the information includes transmitting an indication of an update of the dictionary matrix based on the first reference signal. In some examples, to support receiving the reference signal, the reference signal component 725 is capable of, configured to, or operable to support a means for receiving a second reference signal that is transmitted from a second quantity of one or more antenna ports that is less than the first quantity of antenna ports, where transmitting the information includes transmitting information associated with a representative vector that is based on the second reference signal.

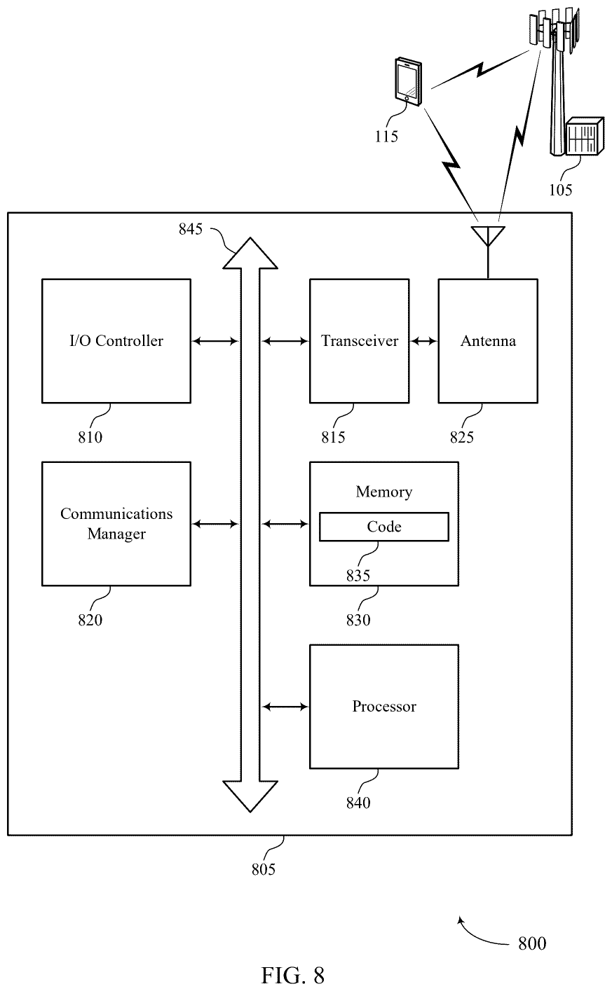

FIG. 8 shows a diagram of a system 800 including a device 805 that supports MIMO channel feedback with dictionary learning in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting MIMO channel feedback with dictionary learning). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a reference signal from a network entity via a MIMO channel, where an estimate of the MIMO channel is generated based on the reference signal. The communications manager 820 is capable of, configured to, or operable to support a means for transmitting information associated with a dictionary matrix for CSF compression, where the information is based on the estimate of the MIMO channel. The communications manager 820 is capable of, configured to, or operable to support a means for communicating data via the MIMO channel, where the data is processed based on the dictionary matrix.

By including or configuring the communications manager 820 in accordance with examples as described herein, the device 805 may support techniques for improved communication reliability, reduced latency, reduced power consumption, more efficient utilization of communication resources, improved coordination between devices, longer battery life, or improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of MIMO channel feedback with dictionary learning as described herein, or the at least one processor 840 and the at least one memory 830 may be otherwise configured to, individually or collectively, perform or support such operations.

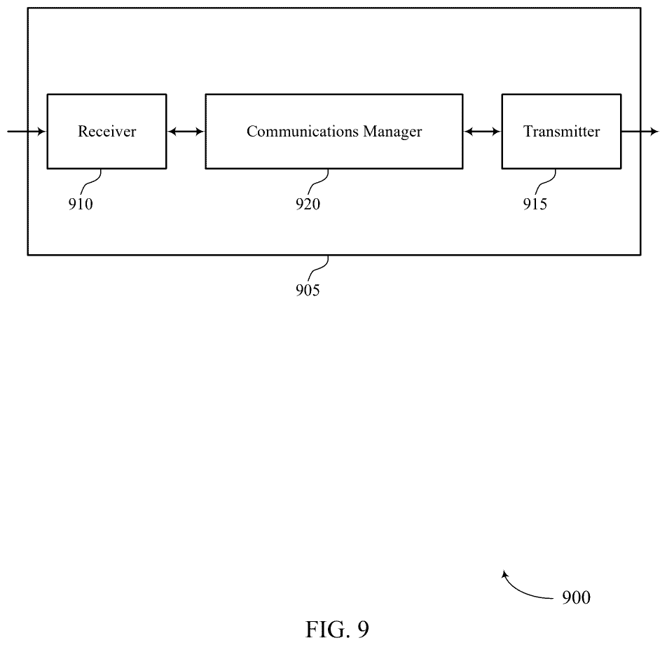

FIG. 9 shows a block diagram 900 of a device 905 that supports MIMO channel feedback with dictionary learning in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of MIMO channel feedback with dictionary learning as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a reference signal from the network entity via a MIMO channel. The communications manager 920 is capable of, configured to, or operable to support a means for obtaining information associated with a dictionary matrix for CSF compression, where the information is based on the reference signal via the MIMO channel. The communications manager 920 is capable of, configured to, or operable to support a means for communicating data via the MIMO channel, where the data is processed based on the dictionary matrix.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, or more efficient utilization of communication resources.

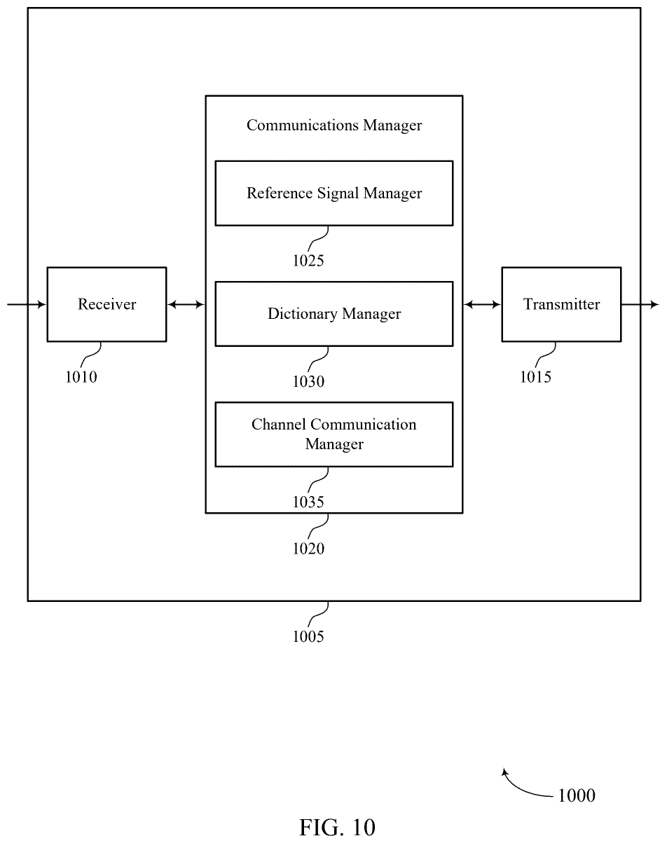

FIG. 10 shows a block diagram 1000 of a device 1005 that supports MIMO channel feedback with dictionary learning in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of MIMO channel feedback with dictionary learning as described herein. For example, the communications manager 1020 may include a reference signal manager 1025, a dictionary manager 1030, a channel communication manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The reference signal manager 1025 is capable of, configured to, or operable to support a means for outputting a reference signal from the network entity via a MIMO channel. The dictionary manager 1030 is capable of, configured to, or operable to support a means for obtaining information associated with a dictionary matrix for CSF compression, where the information is based on the reference signal via the MIMO channel. The channel communication manager 1035 is capable of, configured to, or operable to support a means for communicating data via the MIMO channel, where the data is processed based on the dictionary matrix.

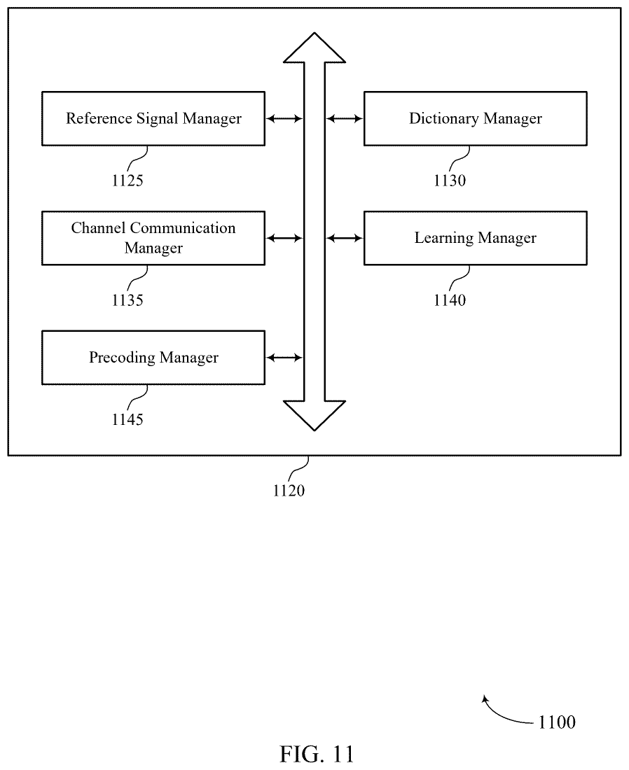

FIG. 11 shows a block diagram 1100 of a communications manager 1120 that supports MIMO channel feedback with dictionary learning in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of MIMO channel feedback with dictionary learning as described herein. For example, the communications manager 1120 may include a reference signal manager 1125, a dictionary manager 1130, a channel communication manager 1135, a learning manager 1140, a precoding manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The reference signal manager 1125 is capable of, configured to, or operable to support a means for outputting a reference signal from the network entity via a MIMO channel. The dictionary manager 1130 is capable of, configured to, or operable to support a means for obtaining information associated with a dictionary matrix for CSF compression, where the information is based on the reference signal via the MIMO channel. The channel communication manager 1135 is capable of, configured to, or operable to support a means for communicating data via the MIMO channel, where the data is processed based on the dictionary matrix.

In some examples, to support obtaining the information, the dictionary manager 1130 is capable of, configured to, or operable to support a means for obtaining a first indication of the dictionary matrix. In some examples, to support obtaining the information, the dictionary manager 1130 is capable of, configured to, or operable to support a means for obtaining a second indication of a set of representation vectors, the set of representation vectors being based on the reference signal via the MIMO channel.

In some examples, the dictionary matrix includes a spatial domain dictionary matrix and a frequency domain dictionary matrix.

In some examples, to support obtaining the information associated with the dictionary matrix, the dictionary manager 1130 is capable of, configured to, or operable to support a means for obtaining an indication of a representation vector, an indication of an updated dictionary matrix, an indication of an error matrix, an indication of a set of error vectors, or a combination thereof.

In some examples, the indication of the updated dictionary matrix is transmitted in accordance with a first periodicity and the indication of the representation vector is transmitted in accordance with a second periodicity. In some examples, the second periodicity is shorter than or equal to the first periodicity.

In some examples, the learning manager 1140 is capable of, configured to, or operable to support a means for outputting a signal indicating a configuration of a learning ratio, where the information associated with the dictionary matrix is based on the learning ratio.

In some examples, the precoding manager 1145 is capable of, configured to, or operable to support a means for precoding the reference signal based on the dictionary matrix, where the information associated with the dictionary matrix indicates a representation vector based on the reference signal.

In some examples, to support outputting the reference signal, the reference signal manager 1125 is capable of, configured to, or operable to support a means for outputting a first reference signal from a first quantity of antenna ports, where obtaining the information includes obtaining an indication of an update of the dictionary matrix based on the first reference signal. In some examples, to support outputting the reference signal, the reference signal manager 1125 is capable of, configured to, or operable to support a means for outputting a second reference signal from a second quantity of one or more antenna ports that is less than the first quantity of antenna ports, where obtaining the information includes obtaining information associated with a representative vector that is based on the second reference signal.

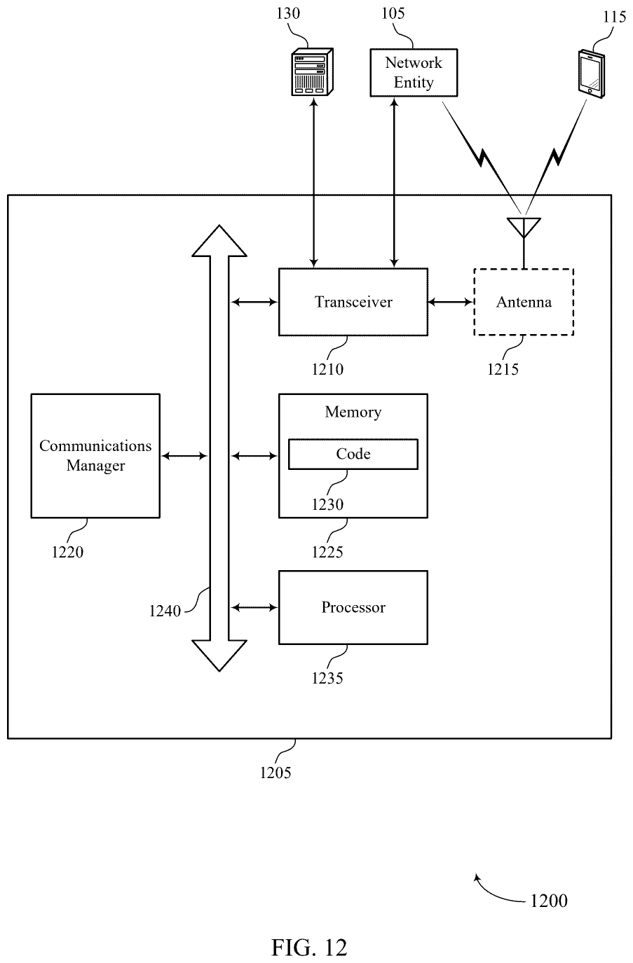

FIG. 12 shows a diagram of a system 1200 including a device 1205 that supports MIMO channel feedback with dictionary learning in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting MIMO channel feedback with dictionary learning). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting a reference signal from the network entity via a MIMO channel. The communications manager 1220 is capable of, configured to, or operable to support a means for obtaining information associated with a dictionary matrix for CSF compression, where the information is based on the reference signal via the MIMO channel. The communications manager 1220 is capable of, configured to, or operable to support a means for communicating data via the MIMO channel, where the data is processed based on the dictionary matrix.

By including or configuring the communications manager 1220 in accordance with examples as described herein, the device 1205 may support techniques for improved communication reliability, reduced latency, reduced power consumption, more efficient utilization of communication resources, improved coordination between devices, longer battery life, or improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of MIMO channel feedback with dictionary learning as described herein, or the at least one processor 1235 and the at least one memory 1225 may be otherwise configured to, individually or collectively, perform or support such operations.

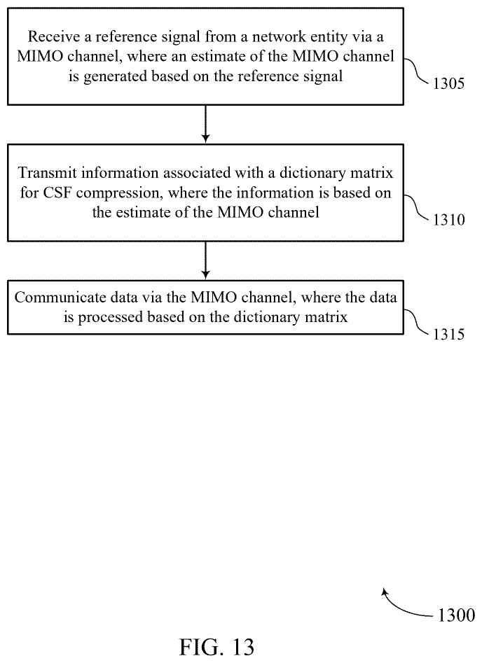

FIG. 13 shows a flowchart illustrating a method 1300 that supports MIMO channel feedback with dictionary learning in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a reference signal from a network entity via a MIMO channel, where an estimate of the MIMO channel is generated based on the reference signal. The operations of 1305 may be performed in accordance with examples as disclosed herein. In some examples, aspects of the operations of 1305 may be performed by a reference signal component 725 as described with reference to FIG. 7.

At 1310, the method may include transmitting information associated with a dictionary matrix for CSF compression, where the information is based on the estimate of the MIMO channel. The operations of 1310 may be performed in accordance with examples as disclosed herein. In some examples, aspects of the operations of 1310 may be performed by a dictionary component 730 as described with reference to FIG. 7.

At 1315, the method may include communicating data via the MIMO channel, where the data is processed based on the dictionary matrix. The operations of 1315 may be performed in accordance with examples as disclosed herein. In some examples, aspects of the operations of 1315 may be performed by a channel communication component 735 as described with reference to FIG. 7.

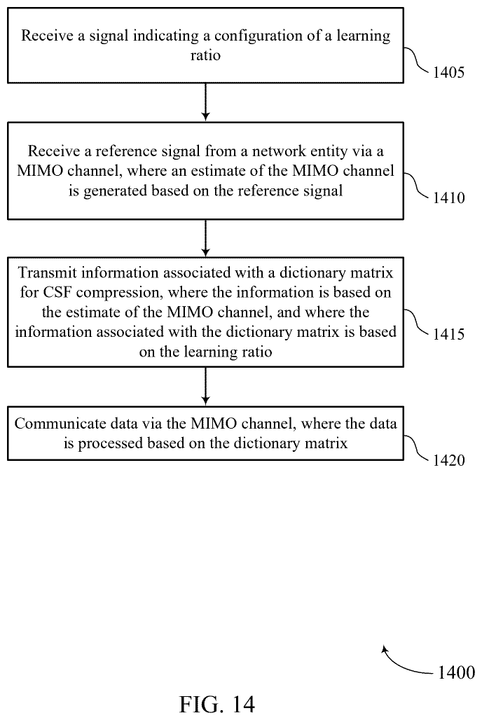

FIG. 14 shows a flowchart illustrating a method 1400 that supports MIMO channel feedback with dictionary learning in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a signal indicating a configuration of a learning ratio, where the information associated with the dictionary matrix is based on the learning ratio. The operations of 1405 may be performed in accordance with examples as disclosed herein. In some examples, aspects of the operations of 1405 may be performed by a learning component 740 as described with reference to FIG. 7.

At 1410, the method may include receiving a reference signal from a network entity via a MIMO channel, where an estimate of the MIMO channel is generated based on the reference signal. The operations of 1410 may be performed in accordance with examples as disclosed herein. In some examples, aspects of the operations of 1410 may be performed by a reference signal component 725 as described with reference to FIG. 7.

At 1415, the method may include transmitting information associated with a dictionary matrix for CSF compression, where the information is based on the estimate of the MIMO channel. The operations of 1415 may be performed in accordance with examples as disclosed herein. In some examples, aspects of the operations of 1415 may be performed by a dictionary component 730 as described with reference to FIG. 7.

At 1420, the method may include communicating data via the MIMO channel, where the data is processed based on the dictionary matrix. The operations of 1420 may be performed in accordance with examples as disclosed herein. In some examples, aspects of the operations of 1420 may be performed by a channel communication component 735 as described with reference to FIG. 7.

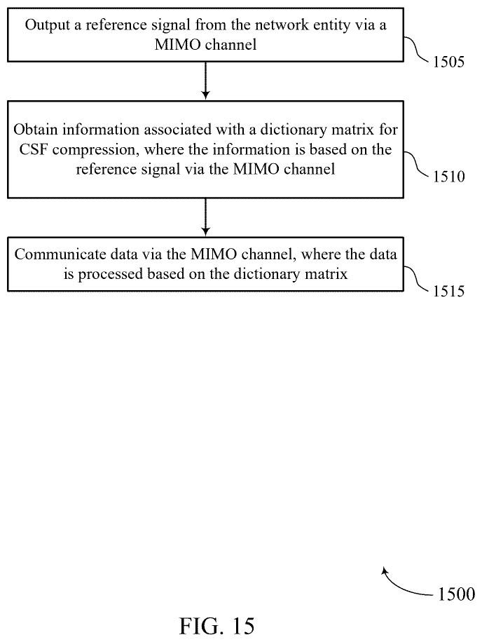

FIG. 15 shows a flowchart illustrating a method 1500 that supports MIMO channel feedback with dictionary learning in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting a reference signal from the network entity via a MIMO channel. The operations of 1505 may be performed in accordance with examples as disclosed herein. In some examples, aspects of the operations of 1505 may be performed by a reference signal manager 1125 as described with reference to FIG. 11.

At 1510, the method may include obtaining information associated with a dictionary matrix for CSF compression, where the information is based on the reference signal via the MIMO channel. The operations of 1510 may be performed in accordance with examples as disclosed herein. In some examples, aspects of the operations of 1510 may be performed by a dictionary manager 1130 as described with reference to FIG. 11.

At 1515, the method may include communicating data via the MIMO channel, where the data is processed based on the dictionary matrix. The operations of 1515 may be performed in accordance with examples as disclosed herein. In some examples, aspects of the operations of 1515 may be performed by a channel communication manager 1135 as described with reference to FIG. 11.

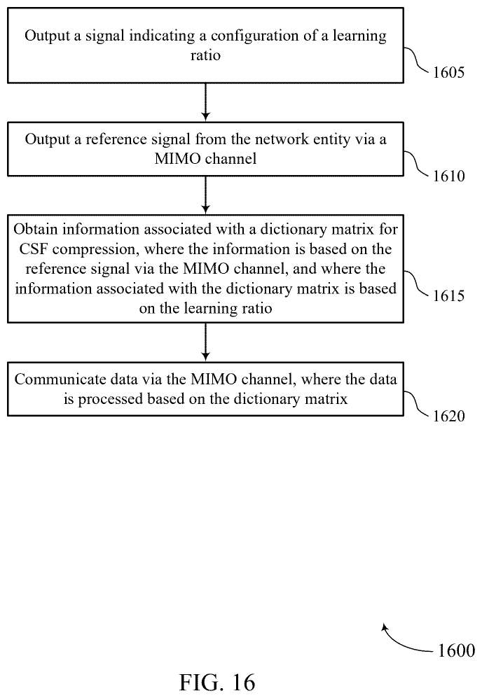

FIG. 16 shows a flowchart illustrating a method 1600 that supports MIMO channel feedback with dictionary learning in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting a signal indicating a configuration of a learning ratio, where the information associated with the dictionary matrix is based on the learning ratio. The operations of 1605 may be performed in accordance with examples as disclosed herein. In some examples, aspects of the operations of 1605 may be performed by a learning manager 1140 as described with reference to FIG. 11.

At 1610, the method may include outputting a reference signal from the network entity via a MIMO channel. The operations of 1610 may be performed in accordance with examples as disclosed herein. In some examples, aspects of the operations of 1610 may be performed by a reference signal manager 1125 as described with reference to FIG. 11.

At 1615, the method may include obtaining information associated with a dictionary matrix for CSF compression, where the information is based on the reference signal via the MIMO channel. The operations of 1615 may be performed in accordance with examples as disclosed herein. In some examples, aspects of the operations of 1615 may be performed by a dictionary manager 1130 as described with reference to FIG. 11.

At 1620, the method may include communicating data via the MIMO channel, where the data is processed based on the dictionary matrix. The operations of 1620 may be performed in accordance with examples as disclosed herein. In some examples, aspects of the operations of 1620 may be performed by a channel communication manager 1135 as described with reference to FIG. 11.

The following provides an overview of aspects of the present disclosure:

Aspect 1: A method for wireless communications at a UE, comprising: receiving a reference signal from a network entity via a MIMO channel, wherein an estimate of the MIMO channel is generated based at least in part on the reference signal; transmitting information associated with a dictionary matrix for CSF compression, wherein the information is based at least in part on the estimate of the MIMO channel; and communicating data via the MIMO channel, wherein the data is processed based at least in part on the dictionary matrix.

Aspect 2: The method of aspect 1, wherein transmitting the information comprises: transmitting a first indication of the dictionary matrix; and transmitting a second indication of a set of representation vectors, the set of representation vectors being based at least in part on the estimate of the MIMO channel.

Aspect 3: The method of aspect 2, wherein the set of representation vectors is based at least in part on a gram matrix of the estimate of the MIMO channel.

Aspect 4: The method of any of aspects 2 through 3, wherein the first indication of the dictionary matrix is transmitted in accordance with a first periodicity and the second indication of the set of representation vectors is transmitted in accordance with a second periodicity, and the second periodicity is shorter than or equal to the first periodicity.

Aspect 5: The method of any of aspects 1 through 4, wherein the dictionary matrix comprises a spatial domain dictionary matrix and a frequency domain dictionary matrix.

Aspect 6: The method of aspect 5, further comprising: compressing the CSF based at least in part on the spatial domain dictionary matrix and the frequency domain dictionary matrix.

Aspect 7: The method of any of aspects 1 through 6, wherein transmitting the information associated with the dictionary matrix comprises: transmitting an indication of a representation vector, an indication of an updated dictionary matrix, an indication of an error matrix, an indication of a set of error vectors, or a combination thereof.

Aspect 8: The method of aspect 7, wherein the indication of the updated dictionary matrix is transmitted in accordance with a first periodicity and the indication of the representation vector is transmitted in accordance with a second periodicity, and the second periodicity is shorter than or equal to the first periodicity.

Aspect 9: The method of any of aspects 1 through 8, further comprising: receiving a signal indicating a configuration of a learning ratio, wherein the information associated with the dictionary matrix is based at least in part on the learning ratio.

Aspect 10: The method of any of aspects 1 through 9, wherein the reference signal is precoded based at least in part on the dictionary matrix, the method further comprising: estimating a representation vector based at least in part on the estimate of the MIMO channel, wherein the information associated with the dictionary matrix indicates the representation vector.

Aspect 11: The method of any of aspects 1 through 10, wherein receiving the reference signal comprises: receiving a first reference signal that is transmitted from a first quantity of antenna ports, wherein transmitting the information comprises transmitting an indication of an update of the dictionary matrix based at least in part on the first reference signal; and receiving a second reference signal that is transmitted from a second quantity of one or more antenna ports that is less than the first quantity of antenna ports, wherein transmitting the information comprises transmitting information associated with a representative vector that is based at least in part on the second reference signal.

Aspect 12: A method for wireless communications at a network entity, comprising: outputting a reference signal from the network entity via a MIMO channel; obtaining information associated with a dictionary matrix for CSF compression, wherein the information is based at least in part on the reference signal via the MIMO channel; and communicating data via the MIMO channel, wherein the data is processed based at least in part on the dictionary matrix.

Aspect 13: The method of aspect 12, wherein obtaining the information comprises: obtaining a first indication of the dictionary matrix; and obtaining a second indication of a set of representation vectors, the set of representation vectors being based at least in part on the reference signal via the MIMO channel.

Aspect 14: The method of any of aspects 12 through 13, wherein the dictionary matrix comprises a spatial domain dictionary matrix and a frequency domain dictionary matrix.

Aspect 15: The method of any of aspects 12 through 14, wherein obtaining the information associated with the dictionary matrix comprises: obtaining an indication of a representation vector, an indication of an updated dictionary matrix, an indication of an error matrix, an indication of a set of error vectors, or a combination thereof.

Aspect 16: The method of aspect 15, wherein the indication of the updated dictionary matrix is transmitted in accordance with a first periodicity and the indication of the representation vector is transmitted in accordance with a second periodicity, and the second periodicity is shorter than or equal to the first periodicity.

Aspect 17: The method of any of aspects 12 through 16, further comprising: outputting a signal indicating a configuration of a learning ratio, wherein the information associated with the dictionary matrix is based at least in part on the learning ratio.

Aspect 18: The method of any of aspects 12 through 17, further comprising: precoding the reference signal based at least in part on the dictionary matrix, wherein the information associated with the dictionary matrix indicates a representation vector based at least in part on the reference signal.

Aspect 19: The method of any of aspects 12 through 18, wherein outputting the reference signal comprises: outputting a first reference signal from a first quantity of antenna ports, wherein obtaining the information comprises obtaining an indication of an update of the dictionary matrix based at least in part on the first reference signal; and outputting a second reference signal from a second quantity of one or more antenna ports that is less than the first quantity of antenna ports, wherein obtaining the information comprises obtaining information associated with a representative vector that is based at least in part on the second reference signal.

Aspect 20: A UE for wireless communications, comprising one or more memories storing processor-executable code, and one or more processors coupled with the one or more memories and individually or collectively operable to execute the code to cause the UE to perform a method of any of aspects 1 through 11.

Aspect 21: A UE for wireless communications, comprising at least one means for performing a method of any of aspects 1 through 11.

Aspect 22: A non-transitory computer-readable medium storing code for wireless communications, the code comprising instructions executable by one or more processors to perform a method of any of aspects 1 through 11.

Aspect 23: A network entity for wireless communications, comprising one or more memories storing processor-executable code, and one or more processors coupled with the one or more memories and individually or collectively operable to execute the code to cause the network entity to perform a method of any of aspects 12 through 19.

Aspect 24: A network entity for wireless communications, comprising at least one means for performing a method of any of aspects 12 through 19.

Aspect 25: A non-transitory computer-readable medium storing code for wireless communications, the code comprising instructions executable by one or more processors to perform a method of any of aspects 12 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a reference signal from a network entity via a multiple-input and multiple-output (MIMO) channel, wherein an estimate of the MIMO channel is generated based at least in part on the reference signal;
transmit information associated with a dictionary matrix for channel status feedback (CSF) compression, wherein the information is based at least in part on the estimate of the MIMO channel; and
communicate data via the MIMO channel, wherein the data is processed based at least in part on the dictionary matrix.

2. The UE of claim 1, wherein, to transmit the information, the one or more processors are individually or collectively operable to execute the code to cause the UE to:
transmit a first indication of the dictionary matrix; and
transmit a second indication of a set of representation vectors, the set of representation vectors being based at least in part on the estimate of the MIMO channel.

3. The UE of claim 2, wherein the set of representation vectors is based at least in part on a gram matrix of the estimate of the MIMO channel.

4. The UE of claim 2, wherein:
the first indication of the dictionary matrix is transmitted in accordance with a first periodicity and the second indication of the set of representation vectors is transmitted in accordance with a second periodicity, and
the second periodicity is shorter than or equal to the first periodicity.

5. The UE of claim 1, wherein the dictionary matrix comprises a spatial domain dictionary matrix and a frequency domain dictionary matrix.

6. The UE of claim 5, wherein the one or more processors are individually or collectively further operable to execute the code to cause the UE to:
compress the CSF based at least in part on the spatial domain dictionary matrix and the frequency domain dictionary matrix.

7. The UE of claim 1, wherein, to transmit the information associated with the dictionary matrix, the one or more processors are individually or collectively operable to execute the code to cause the UE to:
transmit an indication of a representation vector, an indication of an updated dictionary matrix, an indication of an error matrix, an indication of a set of error vectors, or a combination thereof.

8. The UE of claim 7, wherein:
the indication of the updated dictionary matrix is transmitted in accordance with a first periodicity and the indication of the representation vector is transmitted in accordance with a second periodicity, and
the second periodicity is shorter than or equal to the first periodicity.

9. The UE of claim 1, wherein the one or more processors are individually or collectively further operable to execute the code to cause the UE to:
receive a signal indicating a configuration of a learning ratio, wherein the information associated with the dictionary matrix is based at least in part on the learning ratio.

10. The UE of claim 1, wherein the reference signal is precoded based at least in part on the dictionary matrix, and the one or more processors are individually or collectively further operable to execute the code to cause the UE to:
estimate a representation vector based at least in part on the estimate of the MIMO channel, wherein the information associated with the dictionary matrix indicates the representation vector.

11. The UE of claim 1, wherein, to receive the reference signal, the one or more processors are individually or collectively operable to execute the code to cause the UE to:
receive a first reference signal that is transmitted from a first quantity of antenna ports, wherein transmitting the information comprises transmitting an indication of an update of the dictionary matrix based at least in part on the first reference signal; and
receive a second reference signal that is transmitted from a second quantity of one or more antenna ports that is less than the first quantity of antenna ports, wherein transmitting the information comprises transmitting information associated with a representative vector that is based at least in part on the second reference signal.

12. A network entity, comprising:
one or more memories storing processor-executable code; and
one or more processors coupled with the one or more memories and individually or collectively operable to execute the code to cause the network entity to:
output a reference signal from the network entity via a multiple-input and multiple-output (MIMO) channel;
obtain information associated with a dictionary matrix for channel status feedback (CSF) compression, wherein the information is based at least in part on the reference signal via the MIMO channel; and
communicate data via the MIMO channel, wherein the data is processed based at least in part on the dictionary matrix.

13. The network entity of claim 12, wherein, to obtain the information, the one or more processors are individually or collectively operable to execute the code to cause the network entity to:
obtain a first indication of the dictionary matrix; and
obtain a second indication of a set of representation vectors, the set of representation vectors being based at least in part on the reference signal via the MIMO channel.

14. The network entity of claim 12, wherein the dictionary matrix comprises a spatial domain dictionary matrix and a frequency domain dictionary matrix.

15. The network entity of claim 12, wherein, to obtain the information associated with the dictionary matrix, the one or more processors are individually or collectively operable to execute the code to cause the network entity to:
obtain an indication of a representation vector, an indication of an updated dictionary matrix, an indication of an error matrix, an indication of a set of error vectors, or a combination thereof.

16. The network entity of claim 15, wherein:
the indication of the updated dictionary matrix is transmitted in accordance with a first periodicity and the indication of the representation vector is transmitted in accordance with a second periodicity, and
the second periodicity is shorter than or equal to the first periodicity.

17. The network entity of claim 12, wherein the one or more processors are individually or collectively further operable to execute the code to cause the network entity to:
output a signal indicating a configuration of a learning ratio, wherein the information associated with the dictionary matrix is based at least in part on the learning ratio.

18. The network entity of claim 12, wherein the one or more processors are individually or collectively further operable to execute the code to cause the network entity to:
precode the reference signal based at least in part on the dictionary matrix, wherein the information associated with the dictionary matrix indicates a representation vector based at least in part on the reference signal.

19. The network entity of claim 12, wherein, to output the reference signal, the one or more processors are individually or collectively operable to execute the code to cause the network entity to:
output a first reference signal from a first quantity of antenna ports, wherein obtaining the information comprises obtaining an indication of an update of the dictionary matrix based at least in part on the first reference signal; and
output a second reference signal from a second quantity of one or more antenna ports that is less than the first quantity of antenna ports, wherein obtaining the information comprises obtaining information associated with a representative vector that is based at least in part on the second reference signal.

20. A method for wireless communications at a user equipment (UE), comprising:
receiving a reference signal from a network entity via a multiple-input and multiple-output (MIMO) channel, wherein an estimate of the MIMO channel is generated based at least in part on the reference signal;
transmitting information associated with a dictionary matrix for channel status feedback (CSF) compression, wherein the information is based at least in part on the estimate of the MIMO channel; and
communicating data via the MIMO channel, wherein the data is processed based at least in part on the dictionary matrix.
